(19) United States
(12) Patent Application Publication
(10) Pub. No.: US 2025/0095442 A1
(43) Pub. Date: Mar. 20, 2025

(54) Gaming Device with Feature Game Upgrade in Additional Windows and Additional Game Play Characteristics

(71) Applicant: Aristocrat Technologies Australia Pty Limited, North Ryde (AU)

(72) Inventors: Danny Winata, Carlingford NSW (AU); Luke Ireland, Denistone NSW (AU); Antoon Visser, Coogee NSW (AU); Karen Kendall, Toongabbie NSW (AU)

(21) Appl. No.: 18/423,197

(22) Filed: Jan. 25, 2024

(30) Foreign Application Priority Data
Sep. 15, 2023 (AU) 2023229608

(51) Int. Cl. G07F 17/32; G06F 7/58

(52) U.S. Cl. CPC G07F 17/3267; G06F 7/588; G07F 17/3213; G07F 17/3244

(57) ABSTRACT

A gaming device having a display and a processor storing instructions. When executed, the processor conducts a base game in symbols from reel strips are selected using a random number generator. When triggered in the base game with a first game play characteristic, the processor conducts concurrent game instances with the first game play characteristic and separate game outcomes for in at least two game windows using the random number generator. When an upgrade condition corresponding to a second game play characteristic is met in one of the at least two game windows, the processor conducts, for each game window, each remaining feature game instance of the plurality of feature game instances and an additional feature game instance with the second game play characteristic added with separate game outcomes for each game window.

### RELATED APPLICATION

The present application is a continuation of and claims priority to Australian Application No. 2023229608, filed Sep. 15, 2023, and entitled “Gaming Device with Feature Game Upgrades in Two or More Windows” which is hereby incorporated by reference in its entirety.

### BACKGROUND

The present application relates to a gaming device, a method of operating a gaming device and a system with feature game upgrades in two or more game windows.

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

There is disclosed a gaming device, a method of operating a gaming device and a system where feature games can be upgraded. In the example, a number of different feature games can be triggered from a base game which have different game play characteristics. After the feature starts, a game play characteristic can be added when an upgrade condition is met after which an upgraded feature is conducted that has an additional game play characteristic.

One example describes a gaming device comprising a display, a random number generator, a processor, and a memory storing instructions. When the instructions are executed by the processor, they cause the processor to conduct a base game from which a plurality of different feature games can be triggered, wherein the base game comprises a spinning reel game in which the processor selects symbols from reel strips using the random number generator, wherein at least one of the plurality feature games comprises a first game play characteristic comprising conducting concurrent game instances in at least two game windows, upon a feature trigger condition being met in the base game in respect of a feature game comprising at least the first game play characteristic, initiate a plurality of feature game instances in each of the at least two game windows, conduct the initiated feature game instances of each game window by generating separate game outcomes for each game window using the random number generator, upon an upgrade condition corresponding to a second game play characteristic being met during one of the plurality of feature game instances in a respective one of the at least two game windows, set, for each game window, each remaining feature game instance of the plurality of feature game instances and at least one additional feature game instance to be conducted with the second game play characteristic added, and conduct each remaining feature game instance and the at least one additional feature game instance by generating separate game outcomes for each game window using the random number generator.

Another example describes a method of operating a gaming device comprising a display, a random number generator. The method comprises conducting a base game from which a plurality of different feature games can be triggered, wherein the base game comprises a spinning reel game in which the processor selects symbols from reel strips using the random number generator, wherein at least one of the plurality feature games comprises a first game play characteristic comprising conducting concurrent game instances in at least two game windows, upon a feature trigger condition being met in the base game in respect of a feature game comprising at least the first game play characteristic, initiating a plurality of feature game instances in each of the at least two game windows, conducting the initiated feature game instances of each game window by generating separate game outcomes for each game window using the random number generator, upon an upgrade condition corresponding to a second game play characteristic being met during one of the plurality of feature game instances in a respective one of the at least two game windows, setting, for each game window, each remaining feature game instance of the plurality of feature game instances and at least one additional feature game instance to be conducted with the second game play characteristic added, and conducting each remaining feature game instance and the at least one additional feature game instance by generating separate game outcomes for each game window using the random number generator.

Another example describes a system comprising at least one display, a random number generator, one or more processors, and memory storing instructions. When the instructions are executed by the one or more processors, cause the one or more processors to conduct a base game from which a plurality of different feature games can be triggered, wherein the base game comprises a spinning reel game in which the processor selects symbols from reel strips using the random number generator, wherein at least one of the plurality feature games comprises a first game play characteristic comprising conducting concurrent game instances in at least two game windows, upon a feature trigger condition being met in the base game in respect of a feature game comprising at least the first game play characteristic, initiate a plurality of feature game instances in each of the at least two game windows, conduct the initiated feature game instances of each game window by generating separate game outcomes for each game window using the random number generator, upon an upgrade condition corresponding to a second game play characteristic being met during one of the plurality of feature game instances in a respective one of the at least two game windows, set, for each game window, each remaining feature game instance of the plurality of feature game instances and at least one additional feature game instance to be conducted with the second game play characteristic added, and conduct each remaining feature game instance and the at least one additional feature game instance by generating separate game outcomes for each game window using the random number generator.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIG. 6 is a flow chart showing detail of FIG. 5.

FIG. 7 is a flow chart of a method of operating a gaming device.

FIG. 8 is an example screen display.

FIGS. 9 to 14 are example feature indicator states.

FIGS. 15 to 19 are example screen displays.

### DETAILED DESCRIPTION

Examples of the disclosure relate to EGMs where individual feature games comprising individual game play characteristics or composite feature games comprising combined game play characteristics may be triggered from a base game carried out by the EGM. In some feature games, more than one game window may be awarded and symbol collection games may be won independently from each game window. In some feature games, where more than one game window is awarded, an upgrade condition may be met in respect of an individual game window that results in the award of an upgrade comprising a further game play characteristic in each game window.

Further, examples of the present disclosure represent a technical improvement in the art of electronic gaming devices, systems, and operating for such electronic gaming devices or systems. For example, at least some examples of the present disclosure employ a display that provides a visual transformation of one or more gaming windows on a display device with additional game characteristics. In such examples, when a feature game is triggered in a base game, a plurality of concurrent game instances are displayed on the display device simultaneously, which requires the display device be dynamically and graphically configured to accommodate additional game instances. Accommodating additional game instances also provide additional opportunities to provide additional awards or prizes to satisfy a jurisdictional return-to-player (RTP).

Furthermore, the visual addition of additional game instances also provides an improved electronic game device and game display such that the player may only need to focus on the additional prizes and game symbols being displayed, without being overly burdened by complicated calculations. Further, examples of the present disclosure also provide multiple combinational and upgradable game play characteristics in both base games and multiple feature instances, while satisfying the jurisdictional RTP requirements are not conventional. Thus, examples of the present disclosure are not merely new game rules or simply new display patterns, but provide technologic improvements to game display in the art of electronic gaming machines and software for such electronic gaming machines. Moreover, the above example is not intended to be limiting, but merely exemplary of technologic improvements provided by some examples of the present disclosure. Technological improvements of other examples are readily apparent to those of ordinary skill in the art in light of the present disclosure.

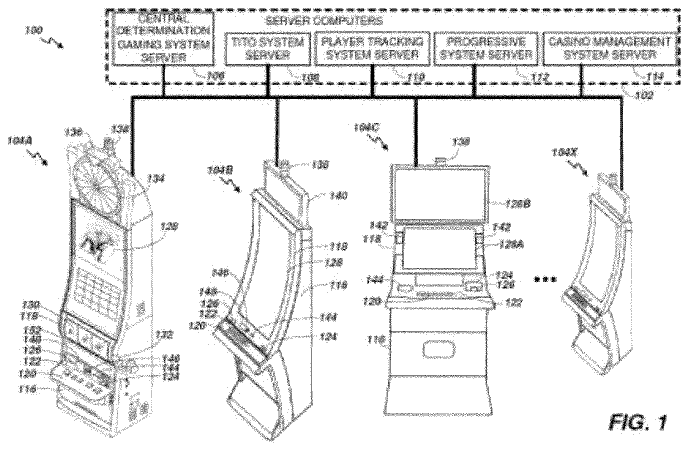

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other examples, the gaming devices 104A-104X may communicate with one another and/or the server computers 102 over RF, cable TV, satellite links and the like.

In some examples, server computers 102 may not be necessary and/or preferred. For example, the present invention may be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In some examples, where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some examples, the bill validator 124 may also function as a “ticket-in” reader that allows the player to use a casino issued credit ticket to load credits onto the gaming device 104A (e.g., in a cashless ticket (“TITO”) system). In such cashless examples, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some examples, a ticket reader can be used which is only capable of reading tickets. In some examples, a different form of token can be used to store a cash value, such as a magnetic stripe card.

In some examples, a player tracking card reader 144, a transceiver for wireless communication with a player's smartphone, a keypad 146, and/or an illuminated display 148 for reading, receiving, entering, and/or displaying player tracking information is provided in EGM 104A. In such examples, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some examples, the information panel(s) 152 may be implemented as an additional video display.

Gaming devices 104A have traditionally also included a handle 132 typically mounted to the side of main cabinet 116 which may be used to initiate game play.

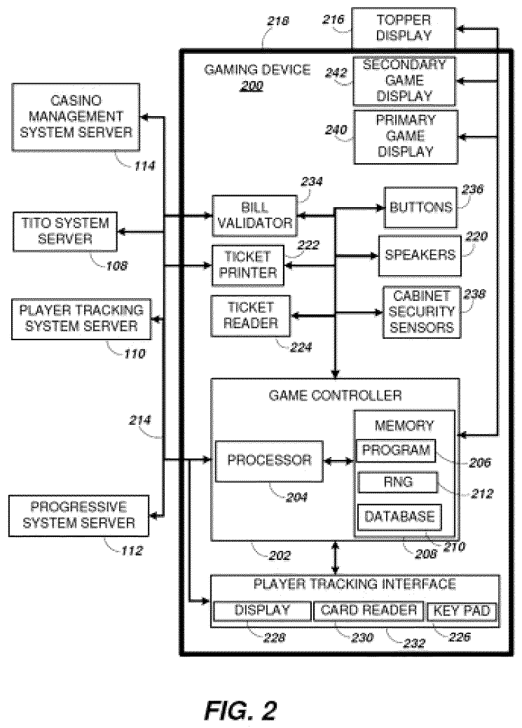

Many or all the above described components can be controlled by circuitry (e.g., a gaming controller) housed inside the main cabinet 116 of the gaming device 104A, the details of which are shown in FIG. 2.

Note that not all gaming devices suitable for implementing examples of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A example are also identified in the gaming device 104B example using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some examples, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some examples, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some examples, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some examples, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some examples, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

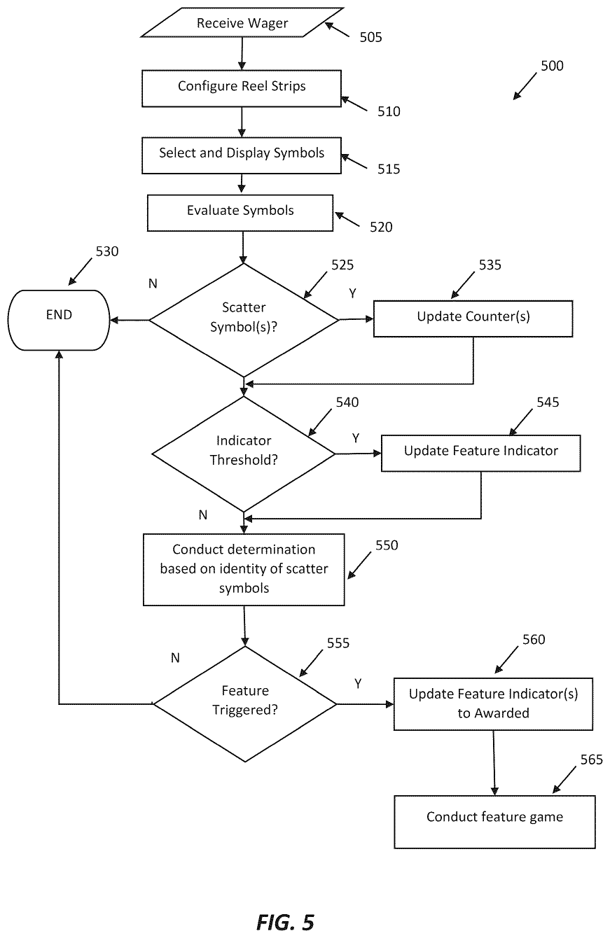

FIG. 5 is a flow chart of an example of a method 500 of operating a gaming device 200. At step 505, processor 204 initiates a base game instance in response to receiving a wager.

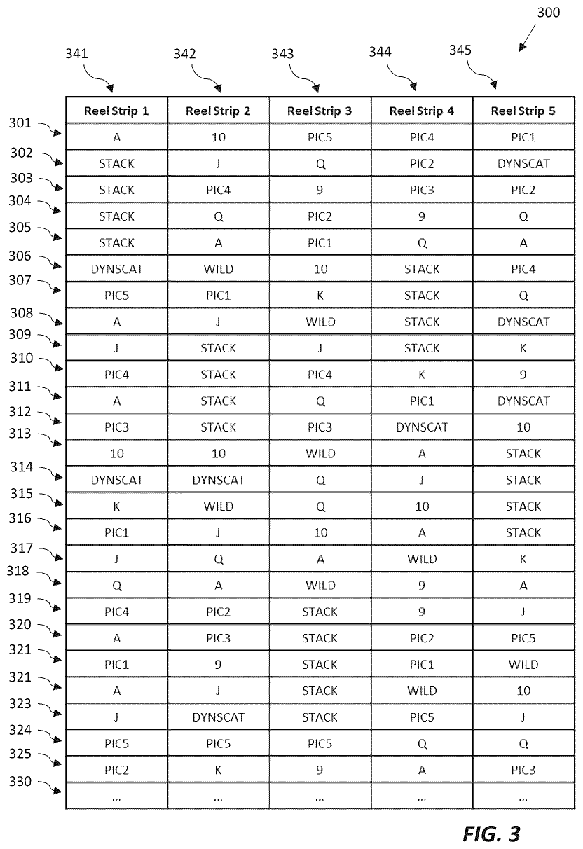

At step 510, processor 204 configures the reel strips for a current game instance in dependence on the received wager. In this respect, FIG. 3 illustrates an example of a set 300 of five reel strips 341, 342, 343, 344, 345. In the example, for illustrative purposes, twenty-five reel strip positions 301-325 are shown for each of the five reel strips 341, 342, 343, 344, 345. Each reel strip position of each reel has a symbol. For example, a “PIC1” symbol occupies the twenty-first reel strip position 321 of the fourth reel 344. The symbols shown on the reel strip are generally indicative of symbols that may be employed in the examples, however, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, the reel strips associated with different columns may be of different lengths to one another.

In this example, reel strips 341-345 have two categories of symbols that are configured: a) STACK symbols, for example at the sixth to ninth reel strip positions 306-309 of the fourth reel strip 344; and b) DYNSCAT symbols, for example the sixth symbol 306 of the first reel strip 341.

In the configuration step 510, processor 204 uses random number generator 212 and a weight table in memory 208 to conduct a single determination as to whether STACK symbols will be the PIC1, PIC2, PIC3, PIC4, PIC5, A, K, Q, J or symbol. That is, all STACK symbols have the same value in a specific game instance.

Also in the configuration step 510, processor 204 uses random number generator 212 and another weight table in memory 208 to independently determine for each DYNSCAT symbol whether it will be SCAT1, SCAT2, SCAT3 or SCAT4 in the current game instance. SCAT1, SCAT2 and SCAT3 are associated with independently triggerable first to third feature games having, respectively, first to third game play characteristics. SCAT4 is associated with a feature game modification comprising a further or fourth game play characteristic, that can result in a composite feature game comprising at least one of the first to third feature games and the fourth game characteristic as described in further detail below.

It will be appreciated that in this description, the numbering of components (such as SCAT symbols, feature games, game play characteristics, etc.) is arbitrary and does not reflect a specific order and is not intended to link a specific number to a specific game play characteristic. Further, the number of a component such as a game play characteristic may vary depending on the context, as generally, the number used reflects the order in which a particular component is introduced in context.

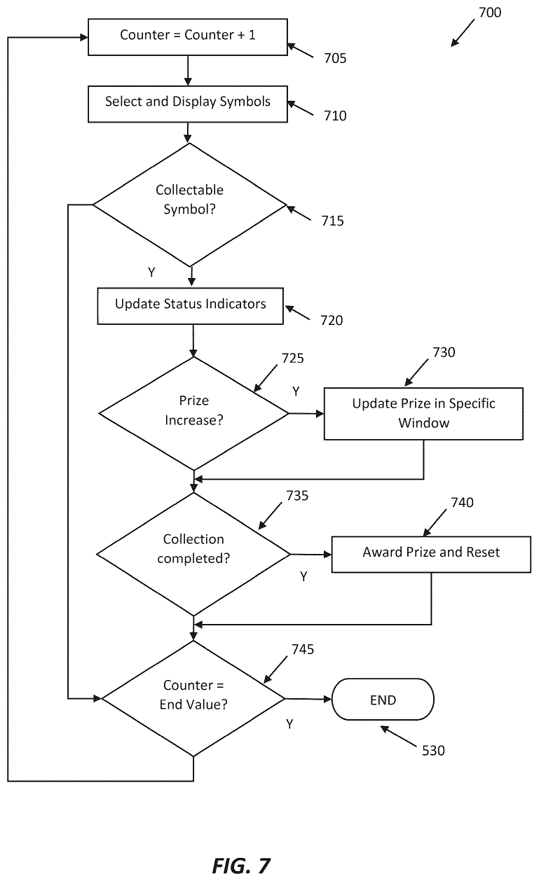

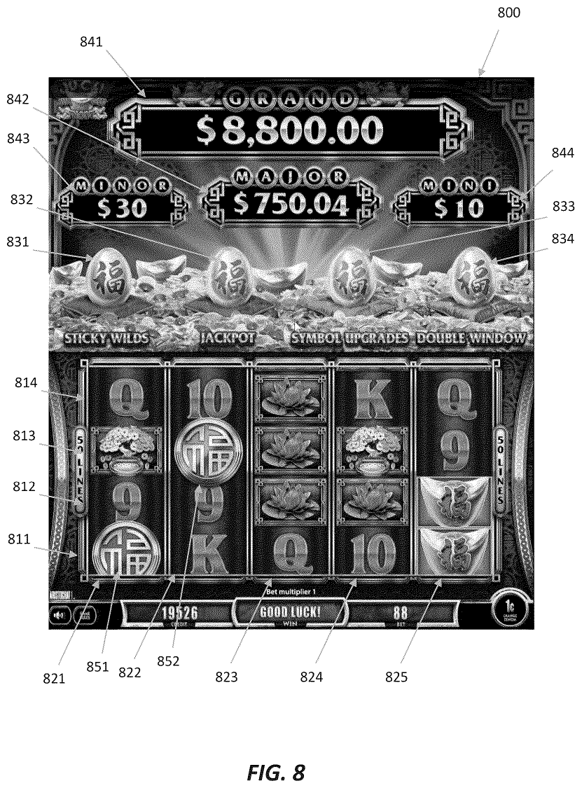

At step 515, processor 204 selects symbols for a spinning reel game and controls the display 240 to display the selected symbols. FIG. 8 shows an example screen display 800 of a base game where symbols are selected from five reel strips for display in five columns of symbol positions 921-925 with four symbols being selected from each reel strip such that there are also four rows 811-814 of symbol positions.

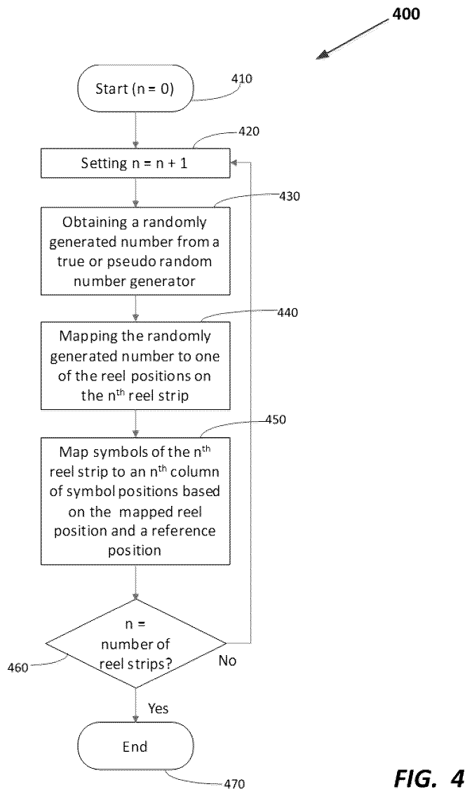

FIG. 4 is a flow chart of an example method 400 carried out by processor 204 to select symbols from reel strips at step 510. At step 410, processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to and nth column of symbol display positions based on the mapped reel position and a reference position. In an example, the reference position is the bottom position of the symbol positions of each column of symbol positions. That is, the symbol positions in bottom row 811. In this example, the selected reel position (and hence the symbol at this position) is mapped to the bottom symbol position of the column. Referring to the example reel strips of FIG. 3, if the value returned by the RNG 212 is mapped to reel position 313 when four symbols are being selected from each reel as shown in FIG. 8, then for the first reel strip 341, “10” is mapped to a first, bottom symbol position, “PIC3” symbol is mapped to a second symbol position, “A” symbol is mapped to a third symbol position, and “PIC4” symbol is mapped to a fourth, top symbol position.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. In other example, different numbers of symbols may be mapped to different numbers of symbol positions.

After the symbols of all reel strips have been mapped to symbol positions, the processor 204 controls display 240 to display them at the symbol positions as shown for example in FIG. 8. Also displayed, in FIG. 8 are prize indicators 841-844 showing the current values of the Grand Jackpot prize 841, Major Jackpot prize 842, Minor bonus prize 843, and Mini bonus prize 844.

After the symbols are selected, processor 204 evaluates the symbols selected at step 520 for one or more winning combinations based on a pay table stored in memory 208. In this example, processor 204 applies a win line based evaluation by processing the symbols selected to identify instances of the same symbol appearing from left to right on defined sets of symbol positions (lines), comprising one symbol from each column. In an example, there are 50 win lines. Upon there being one or more winning combinations, processor 204 makes an award for each winning combination based on any selected bet multiplier, for example, by adding credit amounts defined by the pay table to a meter such as a win or credit meter in memory 204.

As described above the reel strips 341-345 may be configured with a number of different SCAT symbols which can trigger the feature games and hence can also be considered to be “trigger” symbols. “SCAT” is an abbreviation for a scatter symbol which indicates that the symbol will be evaluated irrespective of the symbol position at which it is selected. That is, SCAT symbols do not have to meet an evaluation criterion such as being on a win line in addition to being selected for display at a symbol position. As indicated above, each SCAT symbol corresponds to a game play characteristic of an individually triggerable feature game or a feature game modification. In the example, the SCAT symbols have visual characteristics of coins that have different colors, wherein each color corresponds to a color of a metamorphic feature indicator 831-834 of an individually triggerable feature game or a feature game modification. Each feature indicator includes the name of the corresponding feature so that the link between symbols and the feature game or feature modification is visually indicated on display 240.

In the example of FIG. 8, the metamorphic feature progress indicators 831-834 are displayed above the symbol positions. In this example, first feature indicator 831 corresponds to a “Sticky Wilds” feature, second feature indicator 832 corresponds to a “Jackpot” feature, third feature indicator 833 corresponds to a “Symbol Upgrades” feature, and fourth feature indicator 834 corresponds to a “Double Window” feature modifier. Each feature indicator 831-834 provides a visual indication of how long it has been since the respective feature was last awarded or indicates that a feature is active. In this respect, each feature indicator has a number of states and each state may correspond to a number range of base games conducted since the last feature was awarded. For example, a first (or initial) state may correspond to 0-4 base games, a second state may correspond to 5-9 base games, etc. In FIG. 8, each feature indicator 831-834 is in the first state.

The “Sticky Wilds” feature involves the award of eight free game instances. The game play characteristic of this feature includes that any WILD symbol that is selected (or which “lands”) at a symbol position not currently occupied by a WILD symbol is held at that symbol position for all subsequent free games. The WILD symbols substitute any symbol in winning combinations. If a second WILD symbol is selected for a symbol position at which a WILD symbol is already held that symbol become WILD×2—i.e. any award involving that symbol will be multiplied by two. The additional WILD symbols increase the chance of processor 204 determining that there are winning combinations when evaluating the symbols. The held WILD symbols are displayed as overlay symbols above the symbol positions such that any coin symbols that are selected are evaluated (e.g. configured DYNSCAT symbols or GOLD SCAT symbols if combined with the Jackpot game play characteristic). Upgrades can be awarded from this feature as explained further below.

In the “Symbol Upgrades” feature, the game play characteristic includes that the reel strips are configured in the same manner described in relation to the base game but each time a SCAT2 symbol is selected for display at a symbol position, a random determination is made by processor 204 using a weight table in memory 208 as to whether to award a credit prize or a symbol upgrade which is displayed by turning the SCAT symbol over. In an example, there is a defined order for awarding symbol upgrades, namely, a first upgrade replaces all PIC5 symbols with PIC1 symbols, a second upgrade replaces all PIC4 symbols with PIC1 symbols, a third upgrade replaces all PIC3 symbols with PIC 1 symbols, and a fourth upgrade replaces all PIC2 symbols with PIC1 symbols. As well as there being a higher chance of PIC1 awards being made, in this example, prizes for winning combinations in a pay table in memory 208 are higher for winning combinations with PIC1 than for each of PIC2, PIC3, PIC 4 and PIC5 such that the prizes awarded after each upgrade will tend to be higher. Upgrades can be awarded from this feature as explained further below.

The “Jackpot” feature is a symbol collection feature game. The game play characteristic of this feature includes that, instead of DYNSCAT symbols becoming SCAT1, SCAT2, SCAT3, or SCAT4, DYNSCAT symbols each become GOLD SCAT. Each time a GOLD SCAT symbol is selected, it can become a collectable symbol. In this example, there are four sets of collectable symbols, each symbol being a letter of the words “GRAND”, “MAJOR”, “MINOR” and “MINI”, that is, corresponding to the prizes/bonuses shown in prize/bonus indicators 841-844, respectively. Different colors are used for each word for disambiguation between letters that are common to multiple words. The prizes/symbols are selected by processor 204 using RNG 212 and a set of weighted tables. In an example, a first weight table determines which one of a plurality of second tables will be used, and each second table specifies weights for selecting a prize or symbol. In an example, selection based on the second tables is without replacement so that each symbol can only be selected once. In an example, for each of the MINOR and MINI bonuses, a separate random determination is conducted by processor 204 to determine whether to award a multiplier in conjunction with a selected letter (e.g. ×2). If this occurs, processor 204 multiplies the value currently displayed by prize indicator by the multiplier such that a larger prize can be won. As there are no SCAT1, SCAT2, SCAT3, or SCAT4, this feature cannot be upgraded.

As indicated above, the “Double Window” feature has a game play characteristic that is only triggerable in combination with at least one of the above feature games and results in the feature game being conducted in two game windows. In other examples, this game play characteristic may be modified to incorporate more windows (e.g. three or four windows), however, two windows is an advantageous number of windows where one of the other game play characteristics is a symbol collection game, as the symbol collection status can be displayed above each game window in manner that the state of the game is apparent as described in more detail below.

It will be appreciated that a number of composite features can be formed from the game play characteristics of the above individually triggerable feature games and the double window game play characteristic.

A first composite feature combines the “Sticky Wilds” and “Symbol Upgrade” game play characteristics and awards eight free game instances. Feature upgrades are available from this composite feature.

A second composite feature combines the “Sticky Wilds” and “Jackpot” game play characteristics and awards eight free game instances. As indicated above, the sticky WILD symbols are displayed as overlay symbols and any GOLD SCAT symbol that is selected at a position occupied by a sticky WILD symbol will be evaluated. Feature upgrades are not available from this composite feature.

A third composite feature combines the “Sticky Wilds” and “Double Window” game play characteristics and awards eight free game instances in each of two game play windows. Feature upgrades are available from this composite feature.

A fourth composite feature combines the “Symbol Upgrades” and “Jackpot” game play characteristics and awards eight free game instances. Feature upgrades are not available from this composite feature.

A fifth composite feature combines the “Symbol Upgrades” and “Double Window” game play characteristics and awards eight free game instances in each of two game play windows. Feature upgrades are available from this composite feature.

A sixth composite feature combines the “Jackpot” and “Double Window” game play characteristics and awards eight free game instances in each of two game play windows such that Jackpot and Bonus prizes can be won in either window. Feature upgrades are not available from this composite feature.

A seventh composite feature combines the “Sticky Wilds”, “Symbol Upgrades”, and “Jackpot” game play characteristics and awards eight free game instances. Feature upgrades are not available from this composite feature.

An eighth composite feature combines the “Sticky Wilds”, “Symbol Upgrades” and “Double Window” game play characteristics and awards eight free game instances in each of two game play windows. Feature upgrades are available from this composite feature.

A ninth composite feature combines the “Sticky Wilds”, “Jackpot” and “Double Window” game play characteristics and awards eight free game instances in each of two game play windows. Feature upgrades are not available from this composite feature.

A tenth composite feature combines the “Symbol Upgrades”, “Jackpot” and “Double Window” game play characteristics and awards eight free game instances in each of two game play windows. Feature upgrades are not available from this composite feature.

An eleventh composite feature combines the “Sticky Wilds”, “Symbol Upgrades”, “Jackpot” and “Double Window” game play characteristics and awards eight free game instances in each of two game play windows. Feature upgrades are not available from this composite feature.

At step 525, processor 204 determines whether the symbols selected include one or more scatter symbols. If processor 204 makes a negative determination, the game instance ends 530. In the example, of FIG. 8, the processor 204 will make a positive determination because there are two scatter symbols, in this example, a first scatter symbol 851 has a color (purple) that corresponds to the “Sticky Wilds” indicator 831, and a second scatter symbol 852 has a color (blue) that corresponds to the “Double Window” indicator 834.

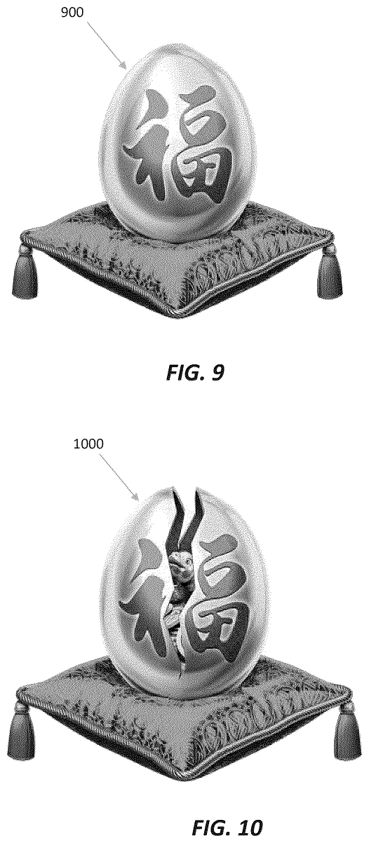

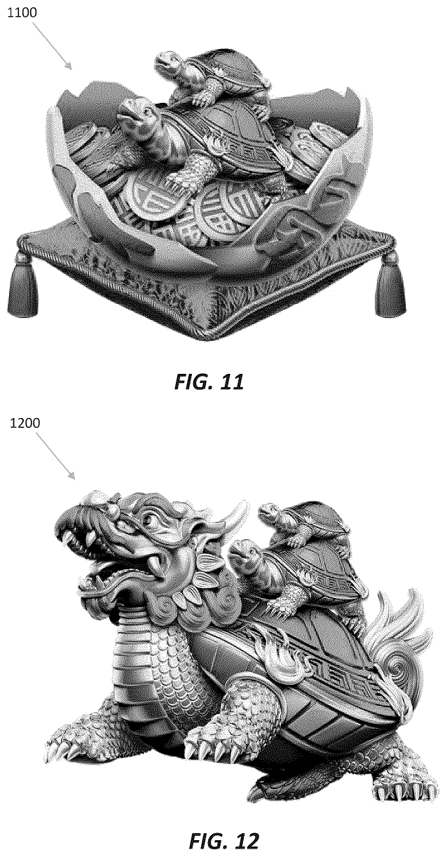

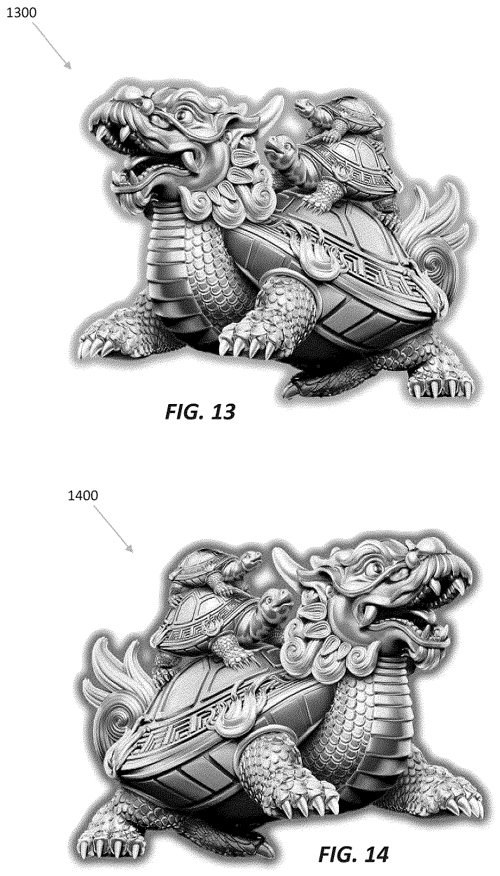

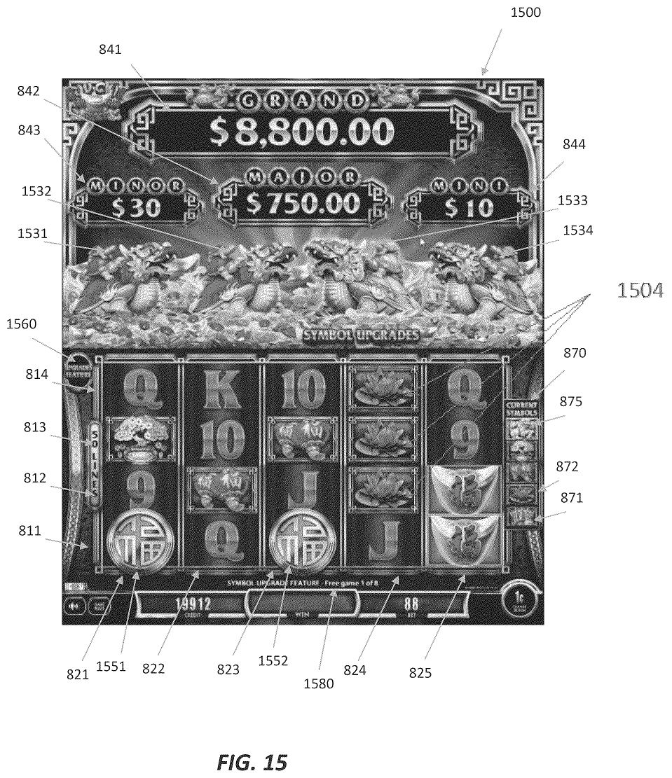

At step 535, processor 204 updates counters in memory 208 corresponding to the relevant feature indicators, in this example counters for the first and fourth feature indicators 831, 834. At step 540, processor 204 determines whether the counter has reached a threshold for changing the indicator—that is, whether it has moved into a new number range and if so, updates the feature indicator at step 545. Example, feature indicator states 900, 1000, 1100, 1200, 1300 and 1400 are shown in FIGS. 9 to 14. Referring to FIGS. 9 to 14, feature indicator states can have a theme reflecting the concept of growth. In this example, a first state 900 shown in FIG. 9 is an unhatched egg. FIG. 10 shows a second state 1000 that is an egg beginning to hatch with a turtle character beginning to emerge. FIG. 11 shows a third state 1100 that includes two turtles emerging from the egg. FIG. 12 shows a fourth state 1200 that illustrates three turtles. FIGS. 13 and 14 show two different award states 1300, 1400 corresponding to a feature being awarded incorporating the relevant game play characteristic as described below. Each of the prize indicators is distinguished by the same color used in the initial state. As shown in FIG. 15, some feature indicators can mirror other indicators in at least some states. In this example, in feature indicators 1531 (transitioned from 831 of FIG. 8), 1532 (transitioned from 832 of FIG. 8), the turtles face one direction (to the right) in at least some states (such as the award state 1400 shown in FIG. 14), and in feature indicators 1533 (transitioned from 833 of FIG. 8), 1534 (transitioned from 834 of FIG. 8), the turtles face an opposite direction or another direction (to the left) as shown in FIG. 15.

At step 550, processor 208 conducts a determination based on identities of the scatter symbols selected. To do so, processor 204 retrieves a weight table based on the identities of the selected trigger symbols from memory 207.

In this respect, Table 1 shows the features that can be triggered from the base game. In an example, a separate weight table is stored in memory 208 for each combination of trigger symbols. As indicated above, there are four game play characteristics, three of which correspond to individually triggerable feature games (Sticky Wilds, Jackpot, Symbol Upgrades) and the fourth corresponds to a feature modifier (Double Window). In Table 1, the following abbreviations are used to show the individual and composite features that are triggerable: A=Sticky Wilds; B=Jackpot; C=Symbol Upgrades; and D=Double Window. As indicated above, the appearance of SCAT 4 on its own cannot result in a feature game being triggered and hence there is either no weight table or the weight table is configured so that it always returns no feature triggered.

TABLE 1

| Trigger Symbols | Possible Features in Weight Table |
|---|---|
| SCAT1 | A = Sticky Wilds |
| SCAT2 | B = Jackpot |
| SCAT3 | C = Symbol Upgrades |
| SCAT4 | D = Double Window |
| | (no weight table) |
| SCAT1, SCAT4 | A, AD |
| SCAT2, SCAT4 | B, BD |
| SCAT3, SCAT4 | C, CD |
| SCAT1, SCAT2, SCAT4 | A, AB, AD, B, BD, ABD |
| SCAT1, SCAT3, SCAT4 | A, AC, AD, C, CD, ACD |
| SCAT2, SCAT3, SCAT4 | B, BC, BD, C, CD, BCD |
| SCAT1, SCAT2, SCAT3 | A, AB, AC, B, BC, C, ABC |
| SCAT1, SCAT2, SCAT3, SCAT4 | A, AB, AC, AD, B, BC, BD, |
| | C, CD, ABC, ABCD |

Each weight table defines a relative probability of each triggerable feature being selected as well a probability of no feature being triggered. For example, where the selected symbols include SCAT1, SCAT2 and SCAT3, an example weight table defines relative probabilities of triggering no feature, Feature A, Feature B, Feature C, Feature AB, Feature AC, Feature BC and Feature ABC. After the weight table is retrieved from memory 208, processor 204 conducts a random determination using RNG 212 and the weight table and either determines that no feature is to be triggered (in which case, the game ends at step 530) or determines that a specific feature is to be triggered.

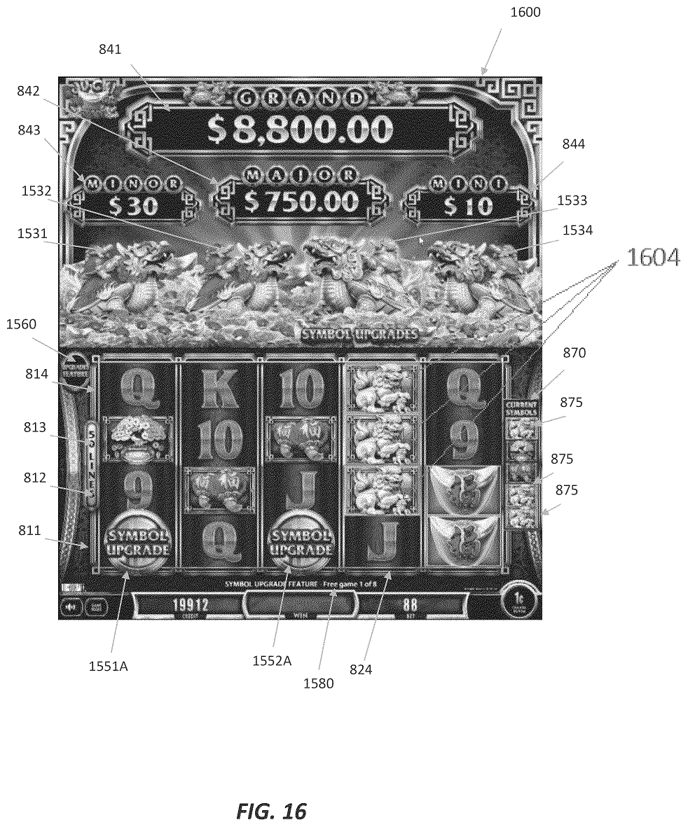

If at step 555, a feature is triggered, processor 204 updates each feature indicator relevant to the triggered feature to an award state such as the award states shown in FIGS. 15 and 16. That is, if, for example, composite feature having both “Sticky Wilds” and “Double Window” is triggered, processor 204 will update first and fourth feature indicators 1531, 1534 to an awarded state at step 560.

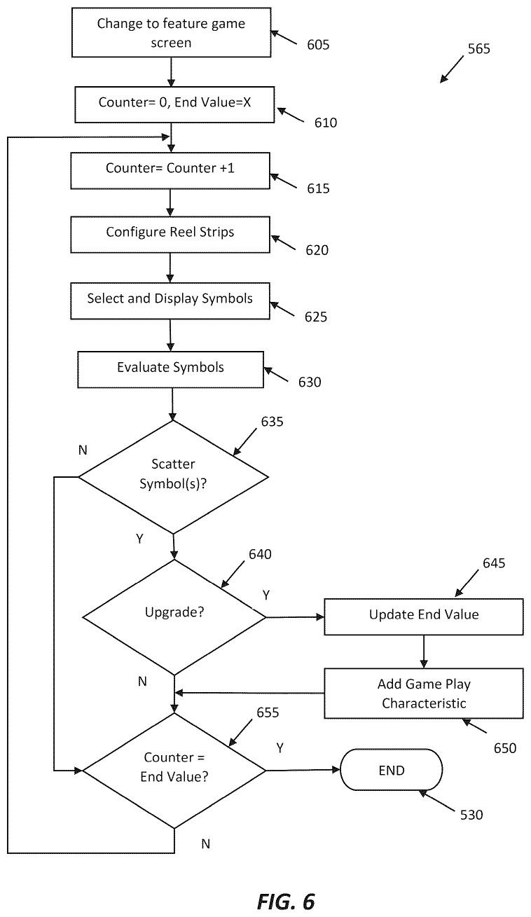

At step 565, processor 204 conducts a feature game as shown in more detail in FIG. 6. At step 605, processor 204 controls the display 240 to transition to a feature screen such as shown in example screen display 1500 of FIG. 15. In this example, a “Symbol Upgrades” feature as indicated by the “Symbol Upgrades” feature indicator 1533 being in an award state. During the feature games, processor 204 controls the display 240 to incorporate a feature state indicator 1560 which indicates which game play characteristics are active, here it includes the message “Upgrade Features”. For the “Symbol Upgrades” feature game, processor 204 also controls the display 240 to display a symbol status indicator 870 that shows which of PIC symbols 1-5 are currently active (here all of them) to thereby indicate a status of the “Symbol Upgrades” feature. Processor 204 also controls the display 240 to display a current free game message 1580 based on the value of the counter and the current end value such that here current free game message has the text “Free game 1 of 8” to indicate that it is the first free game.

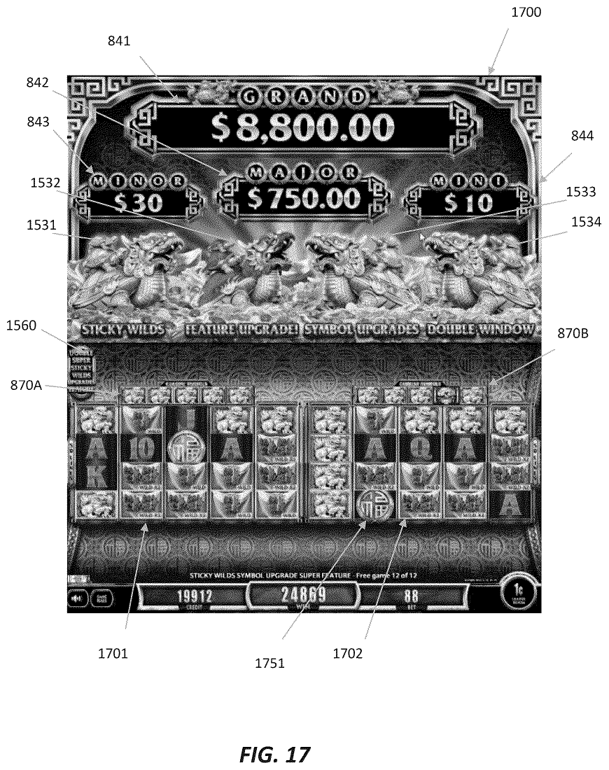

In examples where the awarded feature includes a double window, two windows will be displayed on display 240 when processor 204 transitions to the feature game screen such as shown in the example screen display 1700 of FIG. 17.

At step 610, processor 204 initializes a free game counter to zero and sets an end value for the counter based on a number of free game instances awarded (e.g. to reflect that the processor 204 will conduct 8 game instances). At step 615, processor 204 increments the counter by one to reflect initiation of a game instance.

At step 620, the processor configures the reel strips for use in current game instance. In this example, the makeup of the reel strips depends on the triggered feature, for example, as described above, no trigger symbols are included on the reel strips when the Jackpot game play characteristic is included in the feature game. The reel strips of the feature games may be different to the base game and to one another.

In this example, except where the Jackpot game play characteristic is part of the active feature, configuring the symbols includes configuring DYNSCAT symbols with specific scat symbols so that there is a chance that the feature game will be upgraded to include an additional game play characteristic.

At step 625, processor 204 selects and displays symbols at symbol positions using the process described in relation to FIG. 4 above. In the example of FIG. 15, the symbols selected include two SCAT2 symbols 1551, 1552. As indicated above, in the “Symbol Upgrade” feature, processor 204 conducts a random determination in respect of each SCAT2 symbol 1551, 1552 to determine whether it should award a symbol upgrade or a credit prize. In this example, processor 204 determines that each of the SCAT2 symbols 1551, 1552 will be a “Symbol Upgrade” award and controls the display 240 to reveal the upgrade as shown in example screen display 1600 of FIG. 16, where modified SCAT2 symbols 1551A, 1552A indicate the award of the symbol upgrade. Processor 204 has also updated symbol status indicator 870 to show that PIC5 symbol 871 (of FIG. 15) and PIC4 symbol 872 (Lotus) (of FIG. 15) have been upgraded to PIC1 symbols 875. It will also be apparent that the three PIC4 symbols (Lotus symbols 1504 of FIG. 15) in top three positions of the fourth column 824 of symbol positions have been changed or transitioned to PIC1 symbols (Lion symbols 1604 of FIG. 16).

At step 630, processor 204 evaluates the selected symbols following the symbol upgrade based on pay table in memory 208 and the defined pay lines.

At step 635, processor 204 determines whether there are any scatter symbols related to a possible upgrade, and upon making a negative determination (which will be the case in FIG. 16) proceeds to step 655 and determines whether the counter has reached a current end value.

If processor 204 makes a negative determination at step 655, processor 204 iterates to step 615 and conducts a next feature instance. When processor 204 makes a positive determination that there are scatter symbols at step 635, processor 204 will proceed to determine at step 640 whether to award an upgrade to the feature game by conducting a random determination as to whether to trigger an upgrade for each scatter symbol as described in relation to the base game. Upon making a positive determination at step 640, processor 204 updates the end value at step 645 to include at least one additional game instance (e.g. two game instances) to ensure at least one game instance will be conducted with the added game play characteristic(s). Then at step 650, processor 204 adds the one or more game play characteristic to the feature game, in effect setting the remaining feature game instances and the game instances added by updating the end value to be conducted with the at least one additional game play characteristic. In cases where a game play characteristic is added, processor 204 will always make a negative determination at step 655 and revert to step 615 and iterate through subsequent game instances with the additional game play characteristic.

FIG. 17 is an example of a screen display 1700 when a feature game instance conducted in two game windows 1701, 1702. In the example of FIG. 17, feature game status indicator 1560 indicates that the current composite feature game is a “Double Super Sticky Wilds Upgrades Feature”, where “Super” indicates that the feature game is a composite feature. It will be seen that in this example, individual symbol upgrade indicators 870A, 870B are displayed above the game windows 1701, 1702 and that upgrade indicators 870A, 870B have different states with all symbols upgraded in upgrade indicator 870A, and all but one symbol (PIC2) upgraded in upgrade indicator 870B. The different states of upgrade indicators 870A, 870B result from processor 204 generating independent random game outcomes for each of the game windows.

FIG. 17 also shows an example where processor 204 has selected a SCAT symbol 1751 corresponding to the Jackpot game play characteristic and has updated feature indicator 1532 to indicate that a feature upgrade is to be made. Advantageously, in this example, processor 204 adds the game play characteristic to both game windows 1701, 1702 at step 650. In the case of the Jackpot feature game play characteristic, processor 204 updates the end value to be eight more game instances than the current counter value so that the feature game with the Jackpot game play characteristic will end after eight more game instances.

FIG. 7 is a flow chart 700 of a process of conducting a composite feature game that includes the Double Window and Jackpot game play characteristics. It will be apparent that the process of FIG. 7 is a specific example of conducting a feature game 565. From the above description, it will also be apparent that there are a number of feature games with these game play characteristics. Other game play characteristics are left out of the description of FIG. 7 for clarity. Also for the sake of clarity, FIG. 7 focusses on steps conducted by processor 204 specific to the jackpot games being carried out in two windows. It will be appreciated that the process 700 of FIG. 7 can be adapted to more than two game windows, such as three or four game windows.

At step 705, processor 204 increments a free game counter by one. In this respect, the current value of the counter may be zero or the value of the counter when a jackpot game play characteristic was added.

At step 710, processor 204 independently selects symbols for each of the game windows 1701, 1702 from reel strips configured as described above in relation to a standalone jackpot game. That is, processor 204 carries out the symbol selection process of FIG. 4 independently for each of the game windows 1701, 1702 by obtaining separate numbers from random number generator 212 calls for each of the game windows 1701, 1702.

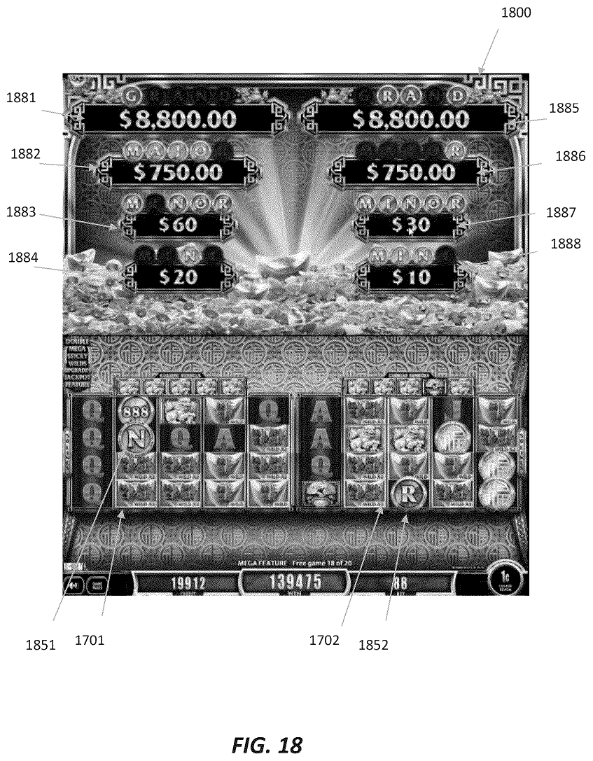

At step 715, processor 204 determines whether the symbols selected include any collectable symbols. In the example of FIG. 18, processor 204 will make a positive determination because an N symbol 1851 corresponding to a Mini Bonus prize (e.g., based on the color red for the Grand Jackpot prize) has been selected in first game play window and an R symbol 1852 corresponding to a Minor Bonus prize (e.g., based on the color green for the Major Jackpot prize) has been selected in second game window.

At step 720, processor 204 updates the symbol collection status indicators for each window. In this respect, FIG. 18 is an example screen display during a feature game including both the double window game play characteristic and the jackpot game play characteristic.

Above first game play window 1701 (or left game window) is a first set of symbol collection status indicators 1881-1884, specifically a Grand Jackpot prize status indicator 1881, a Major Jackpot prize status indicator 1882, a Minor Bonus prize status indicator 1883, and a Minor Bonus prize status indicator 1884.

Above second game play window 1702 (or right game window) is a second set of symbol collection status indicators 1885-1888, specifically a Grand Jackpot prize status indicator 1885, a Major Jackpot prize status indicator 1886, a Minor Bonus prize status indicator 1887, and a Minor Bonus prize status indicator 1888. As such, processor 204 controls the display to display a plurality of sets of collection status indicators for the plurality of game windows in the composite feature game, respectively.

As described above, prizes are awarded when all symbols corresponding to a prize are collected. Each prize status indicator 1881-1888 indicates progress towards completing collection of a defined set of symbols, in this example, visually by collected letters being lit up while other letters are greyed-out. For example, Minor Bonus prize status indicator 1883 has letters M, N, O, and R lit up and letter I greyed out to indicate that symbols M, N, O, and R have been collected and letter I remains to be collected. Also with respect to first window 1701, Mini Bonus prize indicator 1884 has been updated at step 720 to reflect that the N symbol 1851 has been collected. Similarly, in second window, Minor Bonus prize indicator 1886 has been updated to indicate that R symbol 1852 has been collected.

At step 725, processor 204 determines whether a prize increase is associated with the symbol selected. As described above, a prize multiplier may be awarded with symbols associated with the Mini and Minor Bonus prizes. In the example, of FIG. 18, a “×2” multiplier is associated with the N symbol 1701. Accordingly, processor 204 has made a positive determination and at step 730 has updated the prize in the game window 1701. In this respect, it will be observed that while the Grand and Major prize values are the same for the left and right game windows, 1701, 1702, Mini Bonus Prize indicator 1884 shows a value of $20 which is twice the value shown on Mini Bonus Prize indicator 1883 of $10.

At step 735, processor 204 determines whether one or more collections of defined symbols have been completed. In the example of FIG. 18, Minor Bonus prize symbol collection has been completed as shown by Minor Bonus prize indicator 1187. Accordingly, processor 204 proceeds to step 740, controls the display to display or generate an award of the relevant prize, and resets the Minor Bonus prize when the relevant prize has been awarded. Resetting the Grand or Major Jackpot prizes includes resetting a start value of the progressive prize to a preset starting value. Resetting the Minor and Mini Bonus prizes involves resetting the value to a preset value. It will be appreciated that the double window allows game play to be independent in each game window and Jackpot and Bonus prizes to be won from each window and, in some cases, different Bonus prizes to be won in each window.

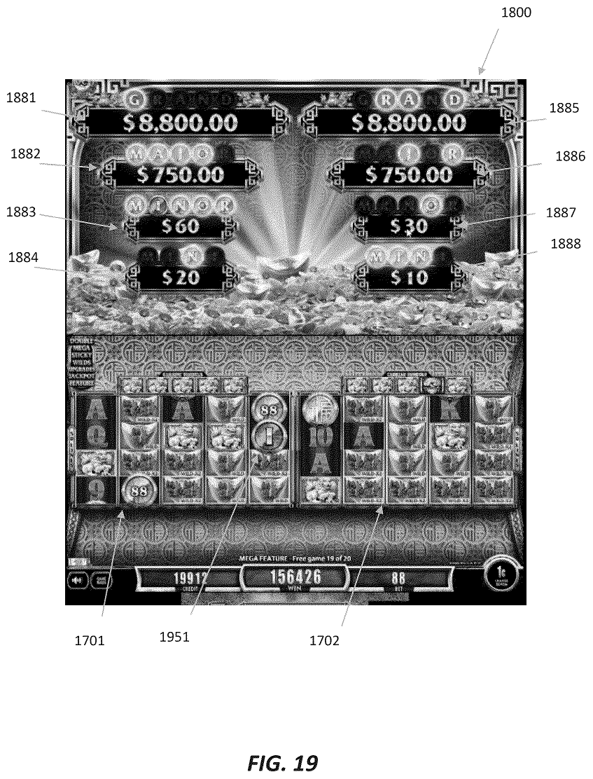

At step 746, processor 204 determines whether the counter has reached the end value and if it hasn't iterates back to step 705 and conducts a further free game instance. FIG. 19 is an example screen display 1900 of a subsequent game instance which shows that processor 204 has now selected the I symbol 1951 required to complete symbol collection for the Minor Bonus prize and associated indicator 1883 has been updated. Thus, FIG. 19 shows that advantageously the same prize can be awarded from different windows and it can have separate values.

### Examples

In an example, there is provided a gaming device comprising: a display; a random number generator; a processor; and a memory storing instructions which, when executed by the processor, cause the processor to: conduct a base game from which a at least one feature game comprising a first game play characteristic and a second game play characteristic can be triggered, wherein the base game comprises a spinning reel game in which the processor selects symbols from reel strips using the random number generator, wherein the first game play characteristic comprises conducting concurrent game instances in at least two game windows, and the second game play characteristic comprises conducting a plurality of feature game instances and making a symbol collection award upon symbols collected in one or more of the plurality of feature game instances meeting an award criterion for at least one of a bonus or jackpot prize; upon a feature trigger condition being met in the base game in respect of a feature game at least one feature game comprising the first game play characteristic and the second game play characteristic, initiate the feature game; and conduct the initiated feature game by conducting a plurality of feature game instances in each game window by generating separate game outcomes for each game window using the random number generator, and collecting symbols independently for each game window whereby a symbol collection award can be won in one or more of the at least two game windows.

In an example, the instructions cause the processor to determine whether to alter a prize value in only one of the at least two game windows such that at least one prize value is only awardable from one of the at least two game windows and at least one prize value is awardable from each of the at least two game windows.

In another example, there is provided a method of operating a gaming device comprising a display, a random number generator, the method comprising: conducting a base game from which a at least one feature game comprising a first game play characteristic and a second game play characteristic can be triggered, wherein the base game comprises a spinning reel game in which the processor selects symbols from reel strips using the random number generator, wherein the first game play characteristic comprises conducting concurrent game instances in at least two game windows, and the second game play characteristic comprises conducting a plurality of feature game instances and making a symbol collection award upon symbols collected in one or more of the plurality of feature game instances meeting an award criterion for at least one of a bonus or jackpot prize; upon a feature trigger condition being met in the base game in respect of a feature game at least one feature game comprising the first game play characteristic and the second game play characteristic, initiating the feature game; and conducting the initiated feature game by conducting a plurality of feature game instances in each game window by generating separate game outcomes for each game window using the random number generator, and collecting symbols independently for each game window whereby a symbol collection award can be won in one or more of the at least two game windows.

In another example, there is provided a system comprising: at least one display; a random number generator; one or more processors; and memory storing instructions which, when executed by the one or more processors, cause the one or more processors to: conduct a base game from which a at least one feature game comprising a first game play characteristic and a second game play characteristic can be triggered, wherein the base game comprises a spinning reel game in which the processor selects symbols from reel strips using the random number generator, wherein the first game play characteristic comprises conducting concurrent game instances in at least two game windows, and the second game play characteristic comprises conducting a plurality of feature game instances and making a symbol collection award upon symbols collected in one or more of the plurality of feature game instances meeting an award criterion for at least one of a bonus or jackpot prize; upon a feature trigger condition being met in the base game in respect of a feature game at least one feature game comprising the first game play characteristic and the second game play characteristic, initiate the feature game; and conduct the initiated feature game by conducting a plurality of feature game instances in each game window by generating separate game outcomes for each game window using the random number generator, and collecting symbols independently for each game window whereby a symbol collection award can be won in one or more of the at least two game windows.

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

What is claimed is:

1. A gaming device comprising:
a display; and
a controller having a processor and a memory storing a plurality of instructions, which, when executed by the processor, cause the processor to:
control the display to display a base game from which at least one of a plurality of feature games is triggered, wherein the base game displays a plurality of symbols randomly selected from reel strips using a random number generated by a random number generator, wherein at least one of the plurality of feature games comprises a first game play characteristic comprising conducting concurrent game instances in at least two game windows,
upon a feature trigger condition being met in the base game in respect of a first feature game comprising at least the first game play characteristic, control the display to display a plurality of feature game instances in the at least two game windows,
control the display to display the feature game instances initiated with game outcomes independently generated for the at least two game windows using the random number generator,
upon an upgrade condition corresponding to a second game play characteristic being met during one of the plurality of feature game instances in one of the at least two game windows, control the display to display remaining feature game instances of the plurality of feature game instances and at least one additional feature game instance with the second game play characteristic added, and
control the display to display each remaining feature game instance and the at least one additional feature game instance with game outcomes independently generated for each game window using the random number generator.

2. The gaming device as claimed in claim 1, wherein each of the at least one of the plurality of feature games having the first game play characteristic is a composite feature game comprising the first game play characteristic and an additional game play characteristic, and wherein the instructions, when executed, cause the processor to conduct each remaining feature game instance and the at least one additional feature game instance in each window with the second game play characteristic and the additional game play characteristic.

3. The gaming device as claimed in claim 2, wherein the additional game play characteristic is a third game play characteristic.

4. The gaming device as claimed in claim 2, wherein there are a plurality of composite feature games triggerable from the base game that comprise the first game play characteristic.

5. The gaming device as claimed in claim 4, wherein the plurality of composite feature games triggerable from the base game that comprise the first game play characteristic are a subset of all composite feature games triggerable from the base game.

6. The gaming device as claimed in claim 1, wherein the second game play characteristic comprises making a symbol collection award upon symbols collected in one or more of the plurality of feature game instances meeting an award criterion for at least one of a bonus or jackpot prize, whereby the symbol collection award is won in one or more of the at least two game windows.

7. The gaming device as claimed in claim 1, wherein each of the feature games is a spinning reel game.

8. A method of operating a gaming device comprising a display, the method comprising:
displaying a base game from which at least one of a plurality of feature games is triggered, including displaying symbols randomly selected from reel strips using a random number generator, wherein the at least one of the plurality of feature games includes a first game play characteristic comprising conducting concurrent game instances in at least two game windows;
upon a feature trigger condition being met in the base game in respect of a feature game comprising at least the first game play characteristic, displaying a plurality of feature game instances in each of the at least two game windows;
displaying in the feature game instances initiated with separate game outcomes generated for each game window using the random number generator;
upon an upgrade condition corresponding to a second game play characteristic being met during one of the plurality of feature game instances in one of the at least two game windows, displaying remaining feature game instances of the plurality of feature game instances and at least one additional feature game instance with the second game play characteristic added; and
displaying game outcomes separately generated for each remaining feature game instance and the at least one additional feature game instance using the random number generator.

9. The method as claimed in claim 8, wherein each of the at least one of the plurality of feature games with the first game play characteristic is a composite feature game having the first game play characteristic and an additional game play characteristic, further comprising conducting each remaining feature game instance and the at least one additional feature game instance in each window with the second game play characteristic and the additional game play characteristic.

10. The method as claimed in claim 9, wherein the additional game play characteristic is a third game play characteristic.

11. The method as claimed in claim 9, wherein there are a plurality of composite feature games triggerable from the base game that comprise the first game play characteristic.

12. The method as claimed in claim 11, wherein the plurality of composite feature games triggerable from the base game that comprise the first game play characteristic are a subset of all composite feature games triggerable from the base game.

13. The method as claimed in claim 8, wherein the second game play characteristic comprises making a symbol collection award upon symbols collected in one or more of the plurality of feature game instances meeting an award criterion for at least one of a bonus or jackpot prize, whereby the symbol collection award is won in one or more of the at least two game windows.

14. The method as claimed in claim 8, wherein each of the feature games is a spinning reel game.

15. A non-transitory computer-readable medium comprising a plurality of instructions in a gaming device that comprises a display and a processor, and the instructions, which, when executed, cause the processor to perform the steps of:
controlling the display to display a base game from which at least one of a plurality of feature games is triggered, including displaying symbols randomly selected from reel strips using a random number generator, wherein the at least one of the plurality of feature games includes a first game play characteristic comprising conducting concurrent game instances in at least two game windows;
upon a feature trigger condition being met in the base game in respect of a feature game comprising at least the first game play characteristic, controlling the display to display a plurality of feature game instances in each of the at least two game windows;
controlling the display to display in the feature game instances initiated with separate game outcomes generated for each game window using the random number generator;
upon an upgrade condition corresponding to a second game play characteristic being met during one of the plurality of feature game instances in one of the at least two game windows, controlling the display to display remaining feature game instances of the plurality of feature game instances and at least one additional feature game instance with the second game play characteristic added; and
controlling the display to display game outcomes separately generated for each remaining feature game instance and the at least one additional feature game instance using the random number generator.

16. The non-transitory computer-readable medium of claim 15, wherein each of the at least one of the plurality of feature games with the first game play characteristic is a composite feature game having the first game play characteristic and a third game play characteristic, and wherein the instructions, when executed, further cause the processor to perform the step of conducting each remaining feature game instance and the at least one additional feature game instance in each window with the second game play characteristic and the third game play characteristic.

17. The non-transitory computer-readable medium of claim 15, wherein there are a plurality of composite feature games triggerable from the base game that comprise the first game play characteristic.

18. The non-transitory computer-readable medium of claim 17, wherein the plurality of composite feature games triggerable from the base game that comprise the first game play characteristic are a subset of all composite feature games triggerable from the base game.

19. The non-transitory computer-readable medium of claim 15, wherein the second game play characteristic comprises making a symbol collection award upon symbols collected in one or more of the plurality of feature game instances meeting an award criterion for at least one of a bonus or jackpot prize, whereby the symbol collection award is won in one or more of the at least two game windows.

20. The non-transitory computer-readable medium of claim 15, wherein each of the feature games is a spinning reel game.
